(19) United States
(12) Patent Application Publication
(10) Pub. No.: US 2008/0075956 A1
(43) Pub. Date: Mar. 27, 2008

(54) Thermo-label

(76) Inventor: Michael Murtha, Swarthmore, PA (US)

Correspondence Address: Galasso & Associates, LP, P.O. Box 26503, Austin, TX, 78755-0503, US

(21) Appl. No.: 11/525,381

(22) Filed: Sep. 22, 2006

(51) Int. Cl. B32B 15/04

(52) U.S. Cl. 428/354; 428/537.5

(57) ABSTRACT

Thermo-Label is an adhesive material with temperature sensitive paper or temperature sensitive tape. Thermo-Label works by adhering it to a shipped or stored product after it is refrigerated or frozen. The temperature sensitive tape or paper will change colors after the product is exposed to temperatures in excess or below the appropriate temperatures for a given item.

### CROSS REFERENCE TO RELATED APPLICATIONS

This Non-Provisional Patent Application does not claim priority to any United States provisional application or any foreign patent applications.

### FIELD OF THE DISCLOSURE

The disclosures made herein relate generally to the food, beverage and pharmaceutical industries. The invention discussed herein is in the general classification of food preservation and freshness devices.

### BACKGROUND

Safely transporting and storing food and drugs is a major concern in many countries, including the United States. The Food and Drug Administration in the United States constantly updates its policies on the shipment and manufacture and maintenance of such items. Often, a product is manufactured by one entity and sent to a distributor who then sends the item to a retail store. Once the product reaches the retail store, a consumer or end user purchases the item.

Many items are either canned or boxed and can be preserved for a long period of time. Other foods or items have labels such as “born on”, “best if used by”, “best if sold by” or “expiration” dates to guide a consumer on how long a product can be used or consumed safely. Unfortunately, many consumers are misled into believing that any product properly consumed by these dates is safe. The reality is that many foods or other items must be kept refrigerated or frozen until consumption to prevent the growth of bacteria or other pathogens. Because a product often passes through a variety of handlers before reaching the consumer, it is important that it is kept at the proper temperature at all stages in the shipping and storage process.

Maintaining an appropriate temperature is particularly critical with deli meats, beef, cheese, chicken, dairy and other similar products. It is also important for a manufacturer to be able to determine at what point in time a product has been exposed to unsafe temperatures to allow the distribution chain to be modified, if necessary, to avoid reoccurrence of the improper handling.

Hence, there is a need in the art for an easy to use, inexpensive and effective labeling device for determining if food or other items have been exposed to improper temperatures prior to consumption.

### SUMMARY OF THE DISCLOSURE

Thermo-Label consists of an adhesive material with temperature sensitive paper or temperature sensitive tape. Thermo-Label works by adhering it to a shipped or stored product, usually after it is refrigerated or frozen. The temperature sensitive tape or paper will change colors after the product is exposed to temperatures in excess of the appropriate temperature for a given item. The temperature sensitive tape or paper will also change colors if a product is exposed to temperatures below a designated temperature.

The principal object of this invention is to provide a device and process for determining if a product has been exposed to temperatures in excess or below specified temperatures

Another object of this invention is to provide an affordable device and method for determining if a product has been exposed to temperatures that would pose a health risk to a consumer.

Another object of this invention is to provide a device and method that will determine how long a product has been exposed to unsafe temperatures.

Yet another object of this invention is to provide a device that allows efficient determination of which point in a storage and distribution chain the product was exposed to excessive temperatures.

### BRIEF DESCRIPTION OF THE DRAWINGS

FIG. 1 depicts a frontal perspective view of one embodiment of the invention.

FIG. 2 depicts a frontal perspective view of another embodiment of the invention.

FIG. 3 depicts a rear perspective view of another embodiment of the invention.

FIG. 4 depicts a frontal view of the preferred embodiment of the invention.

### DETAILED DESCRIPTION OF THE DRAWINGS

Thermo-Label is comprised of at least some of the following: temperature sensitive adhesive tape or adhesive material with pressure sensitive paper applied to a corrugated box or other shipping container.

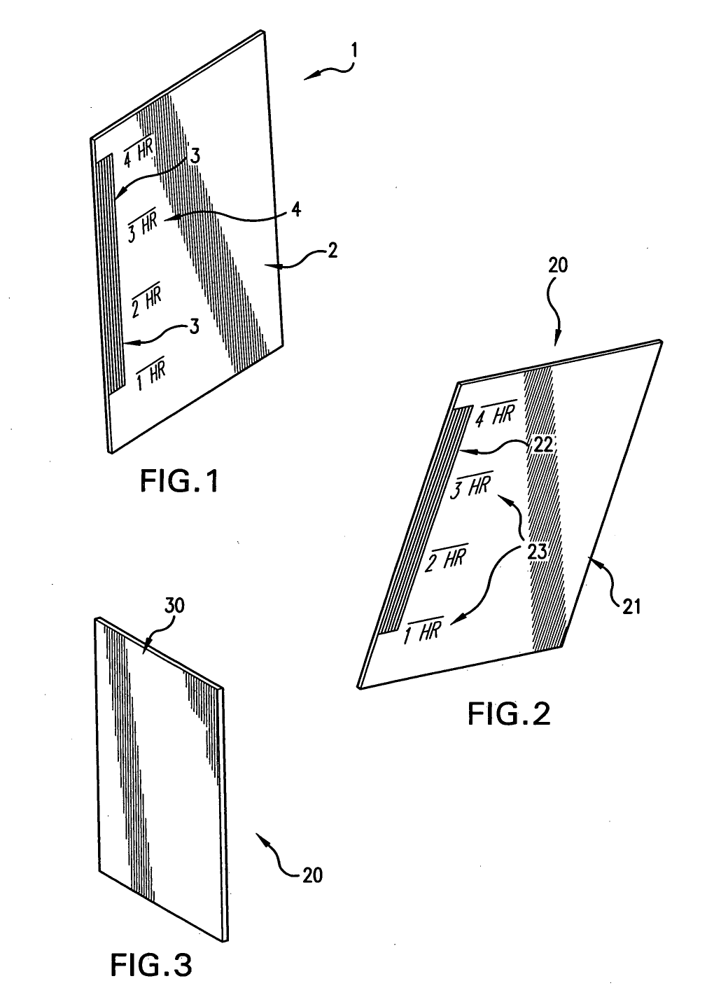

In one embodiment of the invention, shown in FIG. 1, adhesive packaging tape 1 can be placed on corrugated boxes or other shipping containers. The adhesive packaging tape 1 is clear and has temperature sensitive paper 2 on the side opposite the adhesive material. The temperature sensitive paper 2 has a color-changing strip 3 on the far left side with time indicators 4 next to the color-changing strip 3. In this embodiment, the time indicators 4 are shown in four-hour increments. Packaging tape is already well known and used in the industry for shipping products. The greatest advantage of using packaging tape is to provide a color-changing strip 3 on multiple sides of a container or box. In some instances, one side or more of a box could be exposed to excessive temperatures, but not the entire box. If a label was used on only one side of the box, it could falsely report that a product was not exposed to excessive temperatures. Tape, on the other hand, is usually placed on multiple sides of the packaging to secure the product within a box or container. The adhesive packaging tape 1 would have a repeating or constant pattern of color-changing strip 3 and time indicators 4 so that an entire package can be monitored if it is appropriately sealed.

In order to use Thermo-Label, one would first choose a product such as a food, beverage or drug to ship or store. A manufacturer or other user would then package the product in the ordinary manner, typically using a corrugated box or other similar container. The box or container is traditionally sealed with a clear adhesive tape. Instead, the adhesive packaging tape of the current invention would be placed on the box or container to seal it. Ideally, the tape would contact all sides of the box or container. The color-changing strip and time indicators would then be utilized to ascertain at each step in the shipping and storage process whether the box or container was subject to excessive temperatures. The color-changing strip would start as a certain color, such as black. If the box or container were subject to excessive temperatures, such as in excess of 40 degrees Fahrenheit, the color changing-strip would change colors. In the preferred embodiment, the color change would be from black to orange. Once the color-changing strip has changed colors, it will not return to its original color. If prolonged exposure to the excessive temperatures occurs, larger portions of the color-changing strip would begin to change colors to correspond with the time intervals shown on the corresponding time indicator. Likewise, if a box or container were exposed to temperatures below the desired temperature, such as 10 degrees Fahrenheit, the color-changing strip would change to a different color, such as white.

In an alternative use of the invention, a label would be placed on a product or box. In FIG. 2, a frontal perspective view of an alternative embodiment of the invention is shown. On the front of the label 20, temperature sensitive paper 21 has a color-changing strip 22 and printed time indicators 23 aligned with the color-changing strip 22 on the left side.

FIG. 3 shows a rear perspective view of the alternative embodiment of the invention discussed in conjunction with FIG. 2. A protective film 30 covers an adhesive coating (not shown) that is on the side of the label 20 opposite the temperature sensitive paper.

The alternative embodiment of this invention would operate in a similar manner as the preferred embodiment. However, the protective film on the label would need to be removed prior to adhering the label to a product or box. For best results, the labels should be placed on every side of a package or product to insure that no portion of the shipped or stored item has been exposed to improper temperatures.

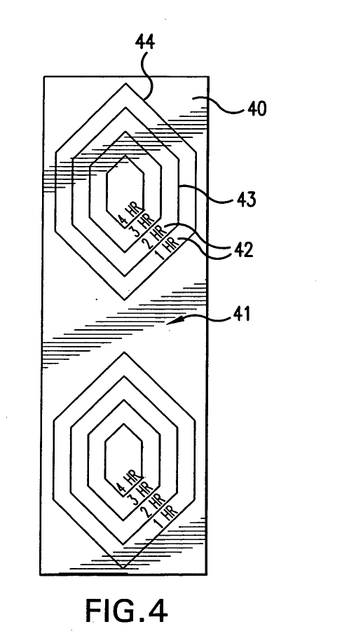

FIG. 4 depicts a frontal view of the preferred embodiment of the invention. In this preferred embodiment of the invention, adhesive packaging tape 40 that is usually two and half inches in width can be placed on corrugated boxes or other shipping containers. The adhesive packaging tape 40 is clear and has temperature sensitive paper 44 embedded within it. The temperature sensitive paper 44 is octagonal in shape and has time indicators 42 that mark the amount of time elapsed using octagonal lines 43. Each octagon of the temperature sensitive paper 44 is approximately two inches in length and width. The gap 41 between two octagons of the temperature sensitive paper 44 is approximately six inches. In this embodiment, the time indicators 42 are shown in one hour increments. In the preferred embodiment, the temperature sensitive paper 44 is activated when it is exposed to oxygen to prevent it from changing colors prior to being applied to a package or product. The preferred embodiment permits the temperature sensitive paper 44 to be insulated from oxygen while it is on the roll of adhesive tape, preventing premature exposure to the elements and possible changing of color.

The preferred embodiment operates in much the same manner as the embodiment described in conjunction with FIG. 1. As the temperature drops or climbs above the appropriate temperature for a selected type of paper, the color of the temperature sensitive paper changes. After the first hour of improper temperature exposure, the paper changes color up to the appropriate outer line of the temperature sensitive paper. With each passing hour of improper temperature exposure, the paper between the corresponding lines changes color until the center is reached. At this point STOP appears in the center of the temperature sensitive paper to indicate that an unacceptable amount of time has elapsed for the given temperature exposure.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

It should be obvious that the label and other components of the present invention can be of various shapes and sizes. In one embodiment, the label is four inches in length and two inches in width and rectangular in shape.

It should also be obvious that the components of the invention can be made of different types of plastics or other suitable materials and can be of any color. While this invention is discussed most frequently in conjunction with the food and beverage industry, it is equally applicable to the drug and pharmaceutical industry or any other industry in which refrigeration or cooling is necessary in the transport and storage of goods or in which maintenance of certain temperatures is desired. It should further be obvious that different colors can be utilized on the color-changing strip and the time indicators could be removed or altered to show additional or less time of exposure. It should further be obvious that the tape or label could be treated with temperature sensitive chemicals rather than already having temperature sensitive capabilities from the manufacturing process. It is also obvious that the entire label or tape could change colors rather than simply having the color-changing strip change colors. A “color-changing mechanism” means any mechanism that causes a discernible difference in the paper or tape that can be seen by an observer when the paper or tape is exposed to temperatures outside the designated range. Often, the color-changing mechanism is in the form of chemicals placed directly on the paper or tape or on a color-changing strip located on the paper or tape.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A temperature sensitive device comprising:
(a) an adhesive tape; and
(b) a color-changing mechanism on the adhesive tape.

2. The temperature sensitive device of claim 1 wherein the color-changing mechanism is a color-changing strip.

3. The temperature sensitive device of claim 1 further comprising
a paper located on the adhesive tape on which the color-changing mechanism is located.

4. The temperature sensitive device of claim 2 wherein a printed time indicator is located next to the color-changing strip.

5. The temperature sensitive device of claim 1 wherein the adhesive tape is clear.

6. The temperature sensitive device of claim 4 wherein the color-changing strip and the printed time indicator extend the length of the adhesive tape.

7. The temperature sensitive device of claim 4 wherein the color-changing strip and printed time indicator repeat along the length of the adhesive tape

8. A temperature sensitive device comprising:
(a) an adhesive material on one side of a label;
(b) a paper on the side of the label opposite the adhesive material; and
(c) a color-changing mechanism on the paper.

9. The device of claim 8 wherein the color-changing mechanism is a color-changing strip.

10. The device of claim 9 wherein a time indicator is located on the paper next to the color-changing strip.

11. The device of claim 8 further comprising
a protective film over the adhesive material.

12. The device of claim 8 wherein the paper is rectangular.

13. A process for monitoring the temperature of products comprising the steps of:
(a) choosing an item to be monitored;
(b) placing adhesive tape with a color-changing mechanism on the item; and
(c) monitoring the color-changing mechanism to determine if the item has been exposed to excessive temperatures.
